(19) United States
(12) Patent Application Publication
(10) Pub. No.: US 2013/0133317 A1
(43) Pub. Date: May 30, 2013

(54) Ambulance Shock-Absorbing Platform for Stretcher

(71) Applicant: Brandon Zumbrum, Debary, FL (US)

(72) Inventor: Brandon Zumbrum, Debary, FL (US)

(21) Appl. No.: 13/304,719

(22) Filed: Nov. 28, 2011

(51) Int. Cl. F15B 15/04

(52) U.S. Cl. 60/325

(57) ABSTRACT

An ambulance shock-absorbing platform for stretcher. The ambulance shock-absorbing platform for stretcher has a plurality of gas actuators mounted to an ambulance floor, and a stage mounted atop the gas actuators. A prime mover drives a pump to actuate the gas actuators to raise the level of the stage to provide shock absorption; a valve may be opened to vent the gas actuators to reduce the stage height for rolling a stretcher on and off the stage. Means to limit the upper and lower stage ends-of-travel is disclosed, and means to control stage height. An M bar and hook are mounted to the stage; a stretcher may be locked into place by means of the M bar, the hook support, and a hook slidably attached to the hook support.

### BACKGROUND OF THE INVENTION

1. Field of the Invention

This invention relates to ambulances, and in particular to an ambulance shock-absorbing platform for stretcher.

2. Background of the Invention

Ambulances are commonly used to transport sick or injured patients from a site of injury, residence or work location to a hospital, clinic or other location where treatment may be provided. Perhaps a patient will be transported by ambulance to an airport where the patient will be transported by air to another location.

A patient is typically placed on a stretcher, and the stretcher is then rolled onto the ambulance floor. Stretchers are usually equipped with hard rubber or plastic wheels, so there is generally no shock absorption function between the stretcher and the ambulance floor.

A common complaint made by patients being transported by ambulance is that the ride is rough and bumpy. The rough and/or bumpy ride patients may experience while reposed on a stretcher in the back of an ambulance can actually be a health and/or safety hazard. For example, where a patient having a cervical spinal fracture is being transported, a rough ambulance ride could actually make the injury worse.

Accordingly, it would be desirable to provide a shock-absorbing platform on the ambulance floor upon which to place a stretcher. In this arrangement, the shock-absorbing platform would provide a smoother, less bumpy ride, to the patient traveling on the stretcher. An ambulance shock-absorbing platform for stretcher could also reduce the chances of further injury to the patient caused by a rough and/or bumpy ambulance ride.

A number of approaches have been taught over the years to address this problem. U.S. Pat. Nos. 7,621,705, 6,890,137, 5,016,862, 2,324,685 and 42,152 were granted to Hillberry et al (first two references), Leyshon, Ekman et al., and Arnold respectively. These devices taught shock absorption by means of mechanical springs. Typically, these designs required modification of the ambulance floor itself, and/or complex mechanical arrangements with multiple linkages in the case of Leyshon '862. Such ambulance modification and complexity could lead to increased cost in these designs. In addition, no provision was made to increase shock absorption function by inflating one or more gas actuators.

U.S. Pat. No. 6,527,263 was granted Verbrugge for a shock-absorbing apparatus which featured mechanical linkages actuated by an air actuator. While this design provided shock-absorption, it was complex, and hence costly.

A number of patents have been issued for shock-absorption capability built into the stretchers themselves. Representative of this approach are U.S. Pat. Nos. 7,124,454, 7,111,340, and 6,942,226 granted to Walkingshaw, Mitchell et al., and Walkingshaw respectively. These designs typically included some type of shock absorption capability built into the stretcher itself. While these patents taught apparatus which provided shock-absorption, the necessity of additional structure and hence increased cost both constituted disadvantages to this way of approaching the problem. In addition, replacement of existing conventional stretchers with shock-absorbing stretchers was required. Where an institution used a mix of conventional stretchers and shock-absorbing stretchers, only the latter's passengers would benefit from the smoother ride provided by the shock-absorbing stretchers.

Still another approach was taught by U.S. Pat. No. 5,135,350 granted Eelman et al. This design provided a wheeled adjustable-height platform with shock-absorptive function as the platform is lowered. A stretcher would be placed atop the platform, and the platform would then be raised to the level of an ambulance floor. The stretcher could then be rolled off the platform and onto the ambulance floor. While this design provided shock absorption to a stretcher on the platform when the platform was lowered, no shock absorption was provided the stretcher once the stretcher was located within the ambulance.

EMS Emergency Mobile Systems published a flyer regarding their Shock Absorbing Hydraulic stretcher Platform EP SA 030. While this system tilted to allow a stretcher to be rolled up-hill onto its platform, no gas shock absorption was taught. Rather, the system was described as hydraulic. Hydraulic fluid is incompressible, and thus makes a poor shock-absorption medium.

Accordingly, it would be desirable to provide a gas shock-absorbing platform which can be quickly and easily mounted to the floor of an existing ambulance, upon which a conventional stretcher may be positioned and immobilized in conventional fashion. Following installation of the stretcher on the platform, it would be beneficial to provide means to inflate a plurality of gas actuators to raise the platform sufficiently to provide shock absorption to the stretcher mounted on the platform, and at the end of the ride, deflation of the gas actuators would lower the platform for egress of the stretcher. The ability to recess the gas actuators in the floor of the ambulance would also be desirable, in an alternate embodiment.

### SUMMARY OF THE INVENTION

Accordingly, it is an object of the present invention to provide an ambulance shock-absorbing platform for stretcher which cushions a stretcher mounted on the platform. Design features allowing this object to be accomplished include a stage supported by a plurality of gas actuators which may be inflated by a pump driven by a prime mover. Advantages associated with the accomplishment of this object include increased patient safety and comfort.

It is another object of the present invention to provide an ambulance shock-absorbing platform for stretcher whose stage may be raised for increased shock absorption, and lowered to move a stretcher onto and off of the stage. Design features allowing this object to be accomplished include a stage supported by a plurality of gas actuators which may be inflated by a pump driven by a prime mover, and a valve which may be opened to reduce gas pressure within the gas actuators. Benefits associated with the accomplishment of this object include increased ease of installing a stretcher on the stage and removing the stretcher from the stage.

It is still another object of this invention to provide an ambulance shock-absorbing platform for stretcher which is quickly and easily installed on an existing ambulance bed. Design features enabling the accomplishment of this object include a plurality of gas actuators having tabs, quick-release fasteners, or other means to attach the gas actuators to an existing ambulance floor. Advantages associated with the realization of this object include reduced work, time and cost in installing the instant ambulance shock-absorbing platform for stretcher to into an existing ambulance.

It is another object of the present invention to provide an ambulance shock-absorbing platform for stretcher which is useable with conventional stretchers. Design features allowing this object to be accomplished include a stage supported by a plurality of gas actuators which may be inflated by a pump driven by a prime mover, an M bar on the platform, and hook slidably attached to a hook support on the platform. Benefits associated with the accomplishment of this object include the ability to use existing stretchers with the instant ambulance shock-absorbing platform for stretcher, along with the associated cost savings of not having to purchase new stretchers.

It is yet another object of this invention to provide an ambulance shock-absorbing platform for stretcher which is inexpensive to produce. Design features allowing this object to be achieved include simplicity of design and the use of components made of readily available materials. Benefits associated with reaching this objective include reduced cost, and hence increased availability.

### BRIEF DESCRIPTION OF THE DRAWINGS

The invention, together with the other objects, features, aspects and advantages thereof will be more clearly understood from the following in conjunction with the accompanying drawings.

Seven sheets of drawings are provided. Sheet one contains FIG. 1. Sheet two contains FIGS. 2-4. Sheet three contains FIGS. 5 and 6. Sheet four contains FIGS. 7 and 8. Sheet five contains FIGS. 9 and 10. Sheet six contains FIGS. 11 and 12. Sheet seven contains FIGS. 13 and 14.

FIG. 1 is left rear quarter side isometric view of a conventional stretcher 10 about to be installed into an existing ambulance 2, on whose ambulance floor 4 the instant ambulance shock-absorbing platform for stretcher 20 has been installed.

FIG. 2 is a left rear quarter side isometric view of a stretcher about to be installed onto a stage.

FIG. 3 is a left rear quarter side isometric view of a stretcher positioned on a stage with its front held in place by an M bar.

FIG. 4 is a left rear quarter side isometric view of a stretcher positioned on a stage with its front held in place by an M bar and its rear held in position by a hook on a hook support engaging the stretcher peg.

FIG. 5 is a left quarter rear isometric view of a gas actuator.

FIG. 6 is a left quarter rear isometric view of an array of interconnected gas actuators installed on an ambulance floor connected to a pump driven by a prime mover.

FIG. 7 is a left quarter rear isometric view of a stage about to be installed atop an array of interconnected gas actuators installed on an ambulance floor connected to a pump driven by a prime mover.

FIG. 8 is a left quarter rear isometric view of a stage installed atop an array of interconnected gas actuators installed on an ambulance floor.

FIG. 9 is a left cross-sectional view of a stage installed atop an array of gas actuators on an ambulance floor, in the down position.

FIG. 10 is a left cross-sectional view of a stage installed atop an array of gas actuators on an ambulance floor, in the up position.

FIG. 11 is a left cross-sectional view of a stage installed atop an array of gas actuators recessed into an ambulance floor, in the down position.

FIG. 12 is a left cross-sectional view of a stage installed atop an array of gas actuators recessed into an ambulance floor, in the up position.

FIG. 13 is a representative schematic of the instant ambulance shock-absorbing platform for stretcher, with the stage in the down position.

FIG. 14 is a representative schematic of the instant ambulance shock-absorbing platform for stretcher, with the stage in the up position.

### DETAILED DESCRIPTION OF THE PREFERRED EMBODIMENT

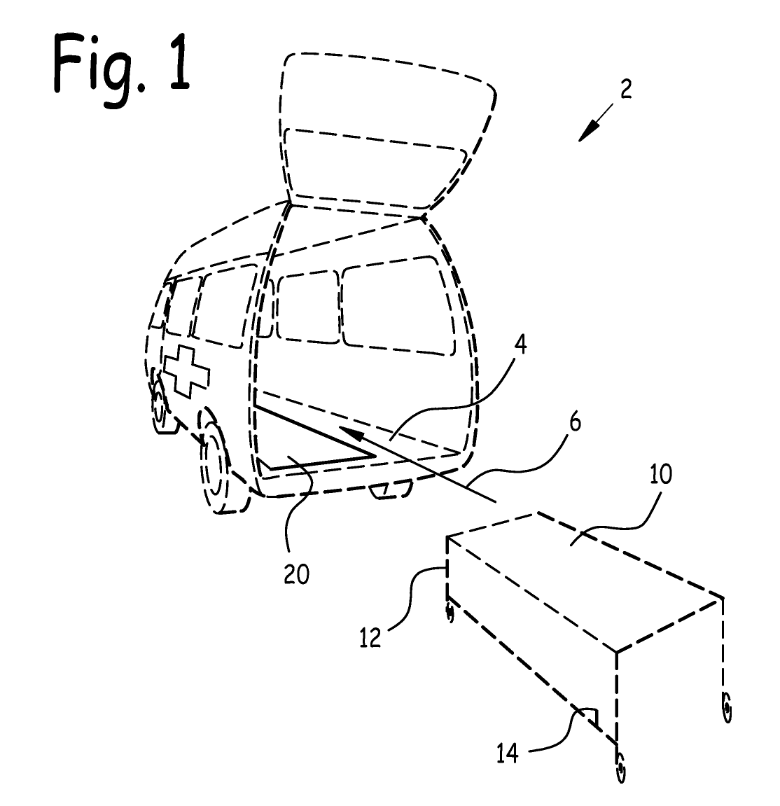

FIG. 1 is left rear quarter side isometric view of a conventional stretcher 10 about to be installed into an existing ambulance 2, on whose ambulance floor 4 the instant ambulance shock-absorbing platform for stretcher 20 has been installed. Stretcher 10 comprises stretcher front legs 12 and stretcher locking peg 14, both of which features are used to immobilize stretcher 10 on ambulance shock-absorbing platform for stretcher 20.

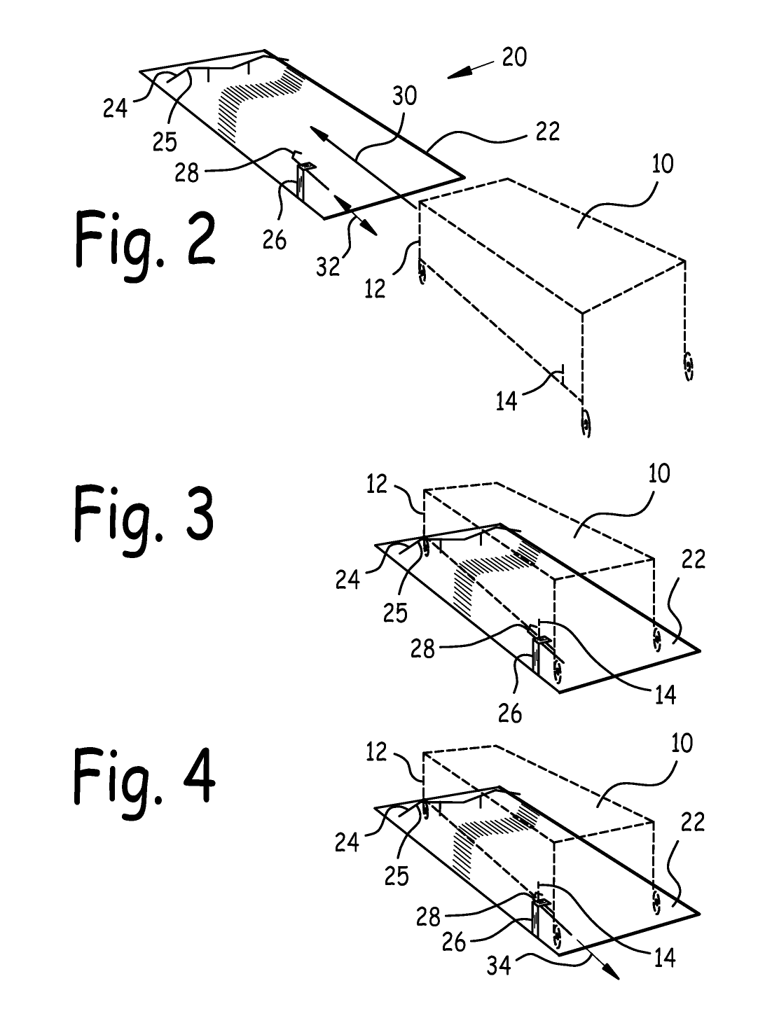

The instant ambulance shock-absorbing platform for stretcher 20 comprises stage 22 upon which stretcher 10 may be removably installed. FIGS. 2-4 depict a stretcher 10 being installed on stage 22. FIG. 2 is a left rear quarter side isometric view of stretcher 10 about to be installed into stage 22. FIG. 3 is a left rear quarter side isometric view of stretcher 10 positioned on stage 22, with its front legs 12 held in place by M bar 24. FIG. 4 is a left rear quarter side isometric view of stretcher 10 positioned on stage 22 with its front legs 12 held in place by M bar 24 and its stretcher locking peg 14 held in position by hook 28 in hook support 26.

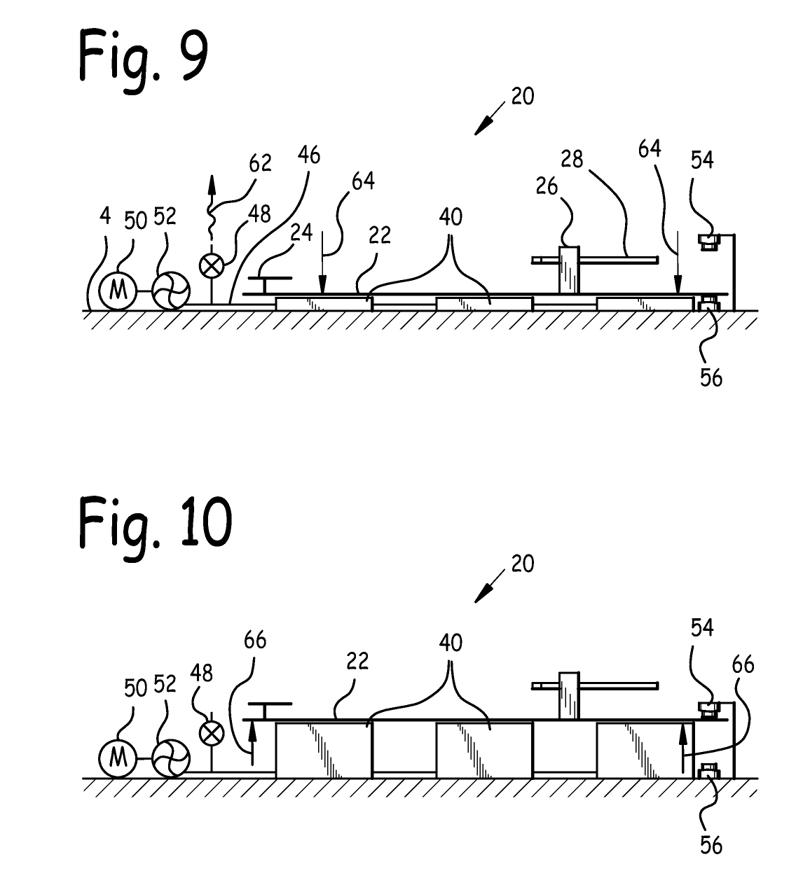

Referring now to these figures, stage 22 is generally flat and horizontal, and sized to co-extend at least with a conventional stretcher 10 when viewed in plan view, from above. Stage 22 comprises a conventional M bar 24 at one end, and a conventional hook 28 reciprocating within a hook support 26. In the instant ambulance shock-absorbing platform for stretcher 20, M bar 24 and hook support 26 are mounted to stage 22, so as to provide the function of immobilizing stretcher 10 on stage 22 while stage 22 elevates and descends as depicted in FIGS. 9-14.

M bar 24 comprises two M bar recesses 25, each sized and positioned to admit a stretcher front leg 12. Hook 28 reciprocates within hook support 26 as indicated by arrow 32 in FIG. 2. Hook 28 is sized to admit stretcher locking peg 14, so that when stretcher locking peg 14 is positioned between hook 28 and hook support 26, hook 26 may be slid into a closed position as indicated by arrow 34 in FIG. 4, in order to lock stretcher locking peg 14 into position between hook 28 and hook support 26.

The stretcher immobilization system employing M bar 24 having M bar recesses 25, stretcher locking peg 14, and hook 28 is commonly used in existing ambulances 2. In a conventional ambulance, M bar 24 would be installed on ambulance floor 4, and hook 28 would be installed on an ambulance wall.

As depicted in FIG. 2, to install stretcher 10 on stage 22, stretcher 10 is first rolled onto stage 22 as indicated by arrow 30, until each stretcher front leg 12 is contained within and butted against a respective M bar recess 25, as depicted in FIG. 3.

Also as depicted in FIG. 3, stretcher locking peg 14 is positioned between hook 28 and hook support 26. Hook 28 is then slid into its closed position as indicated by arrow 34 in FIG. 4, in order to entrap stretcher locking peg 14 between hook 28 and hook support 26. Stretcher 10 is now immobilized on stage 22.

Stretcher 10 may be removed from its position atop stage 22 by reversing the above steps: first hook 28 is slid into its open position opposite arrow 34 in FIG. 4, then stretcher locking peg 14 is removed from its position between hook 28 and hoop support 26; finally stretcher 10 is rolled off stage 22 opposite arrow 30 in FIG. 2.

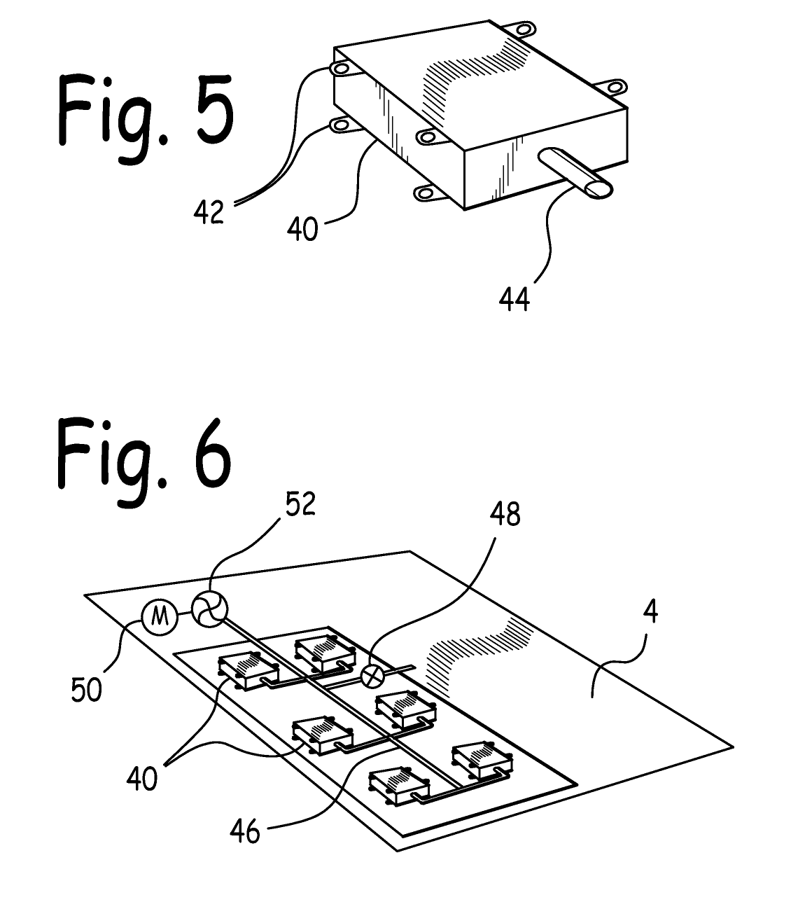

Shock absorption between stage 22 and ambulance floor 4 is provided by gas actuators 40, as depicted in FIGS. 5-14. FIG. 5 is a left quarter rear isometric view of gas actuator 40. As may be observed in this figure, gas actuator 40 comprises port 44, through which gas actuator 40 may be inflated and deflated, so as to vary its height.

Gas actuator 40 may be a gas bladder made of elastic material such as rubber, a bellows, a diaphragm, a piston in cylinder arrangement, or any other appropriate gas actuator. While the figures illustrate gas actuator 40 as an elastic bladder, it is intended to fall within the scope of this disclosure that gas actuator 40 be any appropriate type of gas actuator.

Where gas actuator 40 is an elastic bladder made of elastic material such as rubber, due to the elastic nature of the material from which gas actuator 40 is made, when inflated, the height of gas actuator 40 increases. Conversely, when deflated, the height of gas actuator 40 decreases. Thus, when stage 22 is installed on a plurality of gas actuators 40, when these are inflated stage 22 ascends; when deflated, stage 22 descends.

Gas actuator 40 may optionally incorporate any of a number of attachment means to attach gas actuator 40 to ambulance floor 4 and stage 22. Such attachment may be accomplished by any of a number of attachment means well-known in the art, such as threaded connectors, quick disconnects, adhesive, hook-and-look material, etc. For example, gas actuator 40 may optionally incorporate a number of tabs 42 to attach gas actuator 40 to ambulance floor 4 and stage 22 using threaded connectors, quick-disconnects, etc.

FIG. 6 is a left quarter rear isometric view of an array of interconnected gas actuators 40 installed on ambulance floor 4. The gas actuators 40 are interconnected using lines 46, which may be pneumatic lines. Lines 46 connect gas actuators 40 to pump 52 driven by prime mover 50. Pump 52 driven by prime mover 50 serves to inflate gas actuators 40, thereby increasing their height, and that of stage 22.

The instant ambulance shock-absorbing platform for stretcher 20 also comprises valve 48 connected to gas actuators 40 by lines 46. When valve 48 is opened, gas actuators 40 are vented to atmosphere and deflate, thus decreasing their height and that of platform 22. Thus, the height of platform 22 is increased by closing valve 48 and turning on pump 52. Conversely, the height of platform 22 is decreased by turning off pump 52 and opening valve 48.

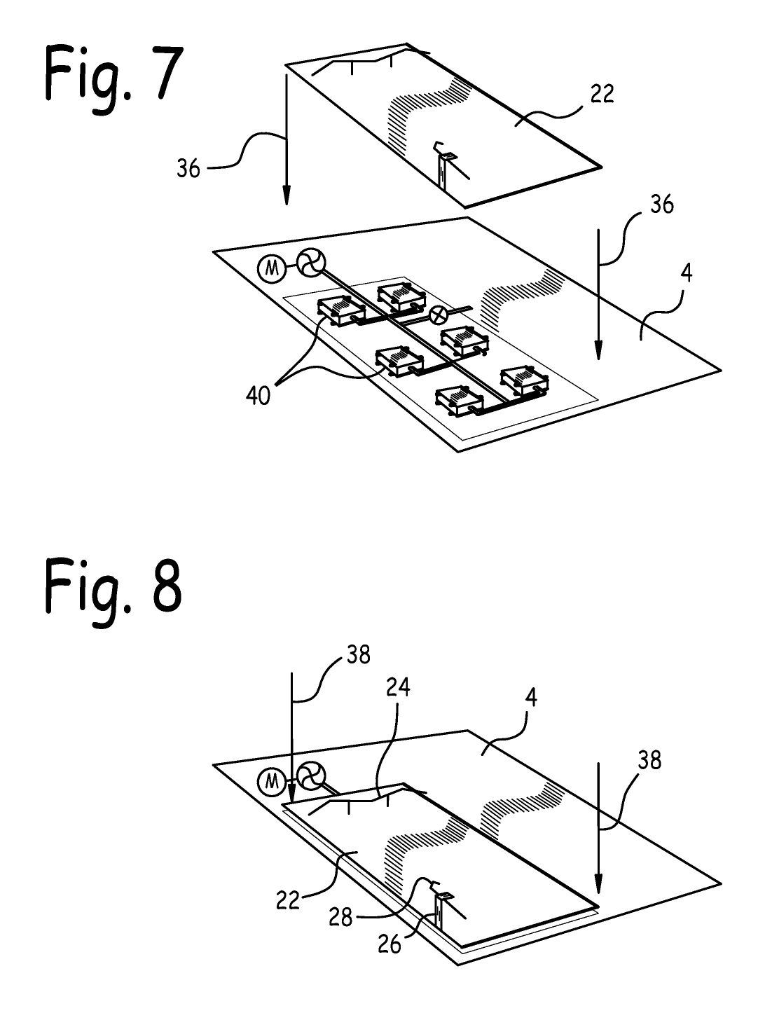

FIG. 7 is a left quarter rear isometric view of stage 22 about to be installed atop an array of interconnected gas actuators 40 installed on ambulance floor 4, as indicated by arrows 36. FIG. 8 is a left quarter rear isometric view of stage 22 installed atop an array of interconnected gas actuators 40 installed on ambulance floor 4, as indicated by arrows 38. As previously noted, M bar 24 and hook support 26 are mounted to stage 22, and hook 28 is slidably attached to hook support 26.

FIG. 9 is a left cross-sectional view of the instant ambulance shock-absorbing platform for stretcher 20 installed on ambulance floor 4, in the down position. It is intended to fall within the scope of this disclosure that any prime mover 50 be used to drive pump 52, including but not limited to an electric motor, gas engine, turbine, nuclear reactor, etc. Means to stop the operation of prime mover 50 when stage 22 reaches its end-of-travel upper position is provided, as well as means to close valve 48 when stage 22 reaches its end-of-travel lower position.

In the representative example illustrated, wherein prime mover 50 is an electric motor, the means to stop the operation of prime mover 50 when stage 22 reaches its end-of-travel upper position is upper end-of-travel limit switch 54, and the means to close valve 48 when stage 22 reaches its end-of-travel lower position is lower end-of-travel limit switch 56.

The electrical system depicted in FIGS. 9-14 is intended to be exemplary only. Where a different type of prime mover 50 is employed, different end-of-travel disconnect means may be used, such as fuel interruption in the case of a gas engine, etc.

As may be observed in FIG. 9, stage 22 is in the down position to facilitate rolling stretcher 10 on and off of stage 22. To reach the down position depicted in FIG. 9, pump 52 is off and valve 48 is opened, allowing gas contained within gas actuators to 40 vent into atmosphere, as indicated by arrow 62. The venting of gas from gas actuators 40 causes stage 22 to descend as indicated by arrows 64 until stage 22 reaches its down position, at which point lower end-of-travel limit switch 56 closes valve 48. Closing valve 48 interrupts the venting of gas from gas actuators 40, and stops their height from decreasing further, thus halting the descent of stage 22 at its down position.

FIG. 10 is a left cross-sectional view of the instant ambulance shock-absorbing platform for stretcher 20 installed on ambulance floor 4, in the up position. To reach the up position depicted in FIG. 9, valve 48 is closed, and pump 52 turned on, thus pumping gas into gas actuators 40. The ingress of gas into gas actuators 40 causes their height, and consequently the height of stage 22, to increase, as indicated by arrows 66. When stage 22 reaches its up position, upper end-of-travel limit switch 54 turns off pump 52, thus halting the ascent of stage 22 at its up position.

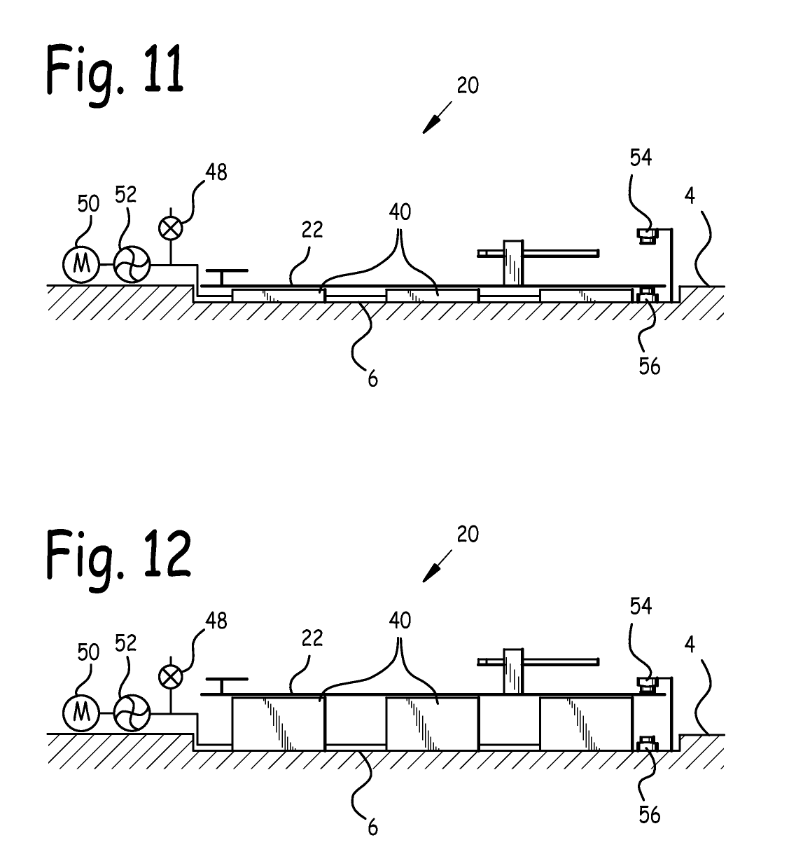

FIGS. 11 and 12 depict an alternate embodiment of the instant ambulance shock-absorbing platform for stretcher 20 wherein gas actuators 40 are recessed into ambulance floor recess 6 in ambulance floor 4, thus placing stage 22 at substantially the same level as ambulance floor 4 when stage 22 is in the down position depicted in FIG. 11. This alternate embodiment would require modification of an existing ambulance 2. If ambulance shock-absorbing platform for stretcher 20 is built into ambulance 2 when ambulance 2 is manufactured, then ambulance floor 4 could be manufactured to incorporate ambulance floor recess 6 to house gas actuators 40.

The operation of the instant ambulance shock-absorbing platform for stretcher 20 depicted in FIGS. 11 and 12 may be the same as describe previously in relation to FIGS. 9 and 10.

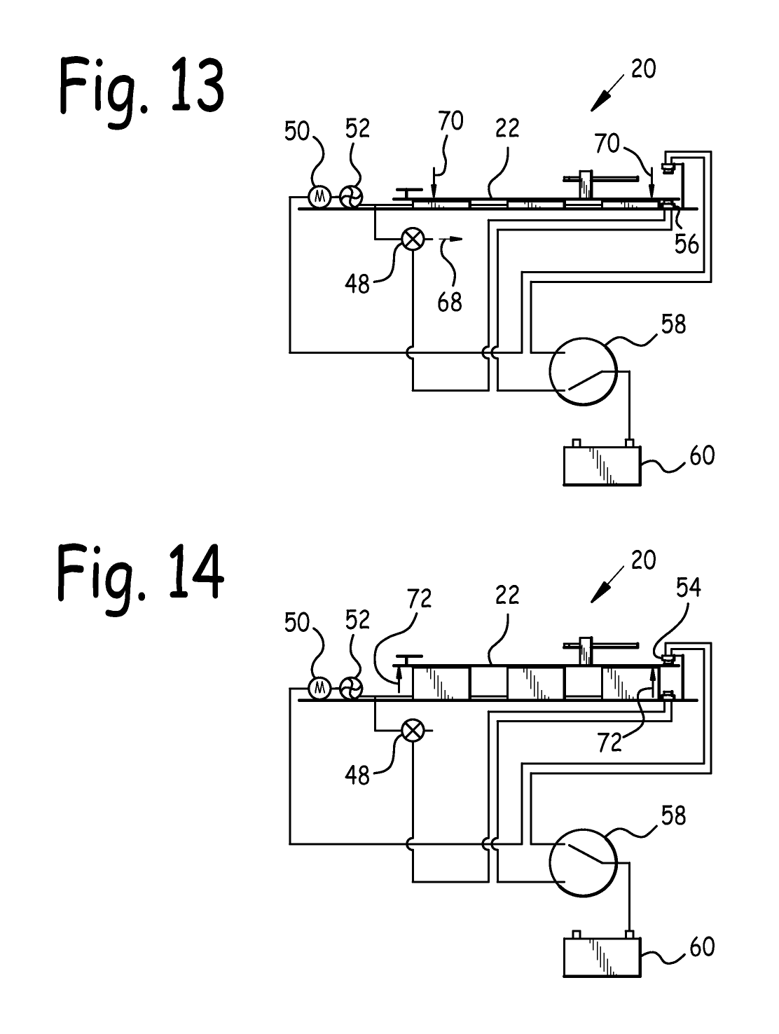

FIG. 13 is a representative schematic of the instant ambulance shock-absorbing platform for stretcher 20, with stage 22 in the down position. In this exemplary schematic, power supply 60 provides electrical power to prime mover 50 through position selection switch 58, and also opens and closes valve 48 through position selection switch 58.

As depicted in FIG. 13, position selection switch 58 is in the down position, thus opening valve 48, which allows gas to vent from gas actuators 40 as indicated by arrow 68. Gas venting from gas actuators 40 through valve 48 allows the height of gas actuators 40 and stage 22 to decrease until the height of stage 22 reaches its lower end-of-travel, as indicated by arrows 70. At that point, lower end-of-travel limit switch 55 closes valve 48 by interrupting power to it, and the descent of stage 22 stops at its lower end-of-travel.

FIG. 14 is a representative schematic of the instant ambulance shock-absorbing platform for stretcher, with stage 22 in the up position. In this exemplary schematic, power supply 60 provides electrical power to prime mover 50 through position selection switch 58, and also opens and closes valve 48 through position selection switch 58.

As depicted in FIG. 14, position selection switch 58 is in the up position, thus maintaining valve 48 closed and allowing power supply 60 to drive pump 52 through prime mover 50. Gas pumped into gas actuators 40 increases the height of gas actuators 40 and stage 22 until the height of stage 22 reaches its upper end-of-travel, as indicated by arrows 72. At that point, upper end-of-travel limit switch 54 closes valve 48 by interrupting power to it, and the ascent of stage 22 stops at its upper end-of-travel.

The schematic depicted in FIGS. 13 and 14 are intended to be conceptually exemplary only. The actual wiring diagram for an electrical embodiment of the instant ambulance shock-absorbing platform for stretcher 20 would include other features, components and connections not illustrated.

In the preferred embodiment, stage 22 was made of metal, synthetic, or any other appropriate material. Gas actuators 40 were bladders, bellows, diaphragms, piston in cylinder, or any other appropriate gas actuator. Where gas actuators 40 bladders, they were made of elastic material such as rubber, or any other appropriate elastic material. Prime mover 50, pump 52, valve 48, upper end-of-travel switch 54 and lower end-of-travel limit switch 56 were commercially available components. Valve 48 was an electrically-actuated valve, or any other appropriate valve. M bar 24, hook 28 and hook support 26 were made of metal, synthetic, or any other appropriate material.

While a preferred embodiment of the invention has been illustrated herein, it is to be understood that changes and variations may be made by those skilled in the art without departing from the spirit of the appending claims.

### DRAWING ITEM INDEX

2 ambulance
4 ambulance floor
6 ambulance floor recess
10 stretcher
12 stretcher front leg
14 stretcher locking peg
20 ambulance shock-absorbing platform for stretcher
22 stage
24 M bar
25 M bar recess
26 hook support
28 hook
30 arrow
32 arrow
34 arrow
36 arrow
38 arrow
40 gas actuator
42 tab
44 port
46 line
48 valve
50 prime mover
52 pump
54 upper end-of-travel limit switch
56 lower end-of-travel limit switch
58 position selection switch
60 power supply
62 arrow
64 arrow
66 arrow
68 arrow
70 arrow
72 arrow

I claim:

1. An ambulance shock-absorbing platform for stretcher comprising a stage mounted to at least one gas actuator, and a prime mover driving a pump, said pump being connected to said at least one gas actuator.

2. The ambulance shock-absorbing platform for stretcher of claim 1 further comprising a valve connected to said at least one gas actuator.

3. The ambulance shock-absorbing platform for stretcher of claim 2 further comprising an M bar and a hook support mounted to said stage, and a hook reciprocating within said hook support.

4. The ambulance shock-absorbing platform for stretcher of claim 2 further comprising means to turn off said pump when said platform reaches an upper end-of-travel, and means to close said valve when said platform reaches a lower end-of-travel.

5. The ambulance shock-absorbing platform for stretcher of claim 4 wherein said prime mover is an electric motor, said means to turn off said pump when said platform reaches an upper end-of-travel comprises an upper end-of-travel limit switch, and said means to close said valve when said platform reaches a lower end-of-travel comprises a lower end-of-travel limit switch.

6. The ambulance shock-absorbing platform for stretcher of claim 5 wherein said valve is an electrically-actuated valve, and further comprising a power supply connected to said valve and said prime mover through a position selection switch.

7. The ambulance shock-absorbing platform for stretcher of claim 6 wherein said position selection switch is connected to said prime mover through said upper end-of-travel limit switch, and said position selection switch is connected to said valve through said lower end-of-travel switch.

8. The ambulance shock-absorbing platform for stretcher of claim 3 wherein said M bar comprises a pair of M bar recesses, each said M bar recess being sized and positioned to accept a respective stretcher front leg.

9. In combination an ambulance and an ambulance shock-absorbing platform for stretcher;
said ambulance comprising an ambulance floor; and
said ambulance shock-absorbing platform for stretcher comprising a stage mounted atop at least one gas actuator, each said gas actuator being attached to said ambulance floor, and a prime mover driving a pump, said pump being connected to said at least one gas actuator.

10. The combination ambulance and ambulance shock-absorbing platform for stretcher of claim 9 further comprising a valve connected to said at least one gas actuator, whereby gas pumped into said gas actuator by said pump increases a height of said gas actuator, said valve selectably venting each said at least one gas actuator to atmosphere.

11. The combination ambulance and ambulance shock-absorbing platform for stretcher of claim 10 further comprising means to turn off said pump when said platform reaches an upper end-of-travel, and means to close said valve when said platform reaches a lower end-of-travel.

12. The combination ambulance and ambulance shock-absorbing platform for stretcher of claim 11 further comprising an M bar and a hook support mounted to said stage, and a hook reciprocating within said hook support, said M bar comprising a pair of M bar recesses, each said M bar recess being sized and positioned to accept a respective stretcher front leg.

13. The combination ambulance and ambulance shock-absorbing platform for stretcher of claim 12 further comprising a stretcher, said stretcher comprising a pair of said stretcher front legs and a stretcher locking peg, said stretcher being disposed on said stage, said hook and said hook support being positioned and sized to admit said stretcher locking peg when each said stretcher front leg is disposed within a respective said M bar recess, said hook locking said stretcher locking peg between said hook and said hook support when said hook is slid into a hook closed position.

14. The combination ambulance and ambulance shock-absorbing platform for stretcher of claim 13 wherein said prime mover is an electric motor, said means to turn off said pump when said platform reaches an upper end-of-travel comprises an upper end-of-travel limit switch, and said means to close said valve when said platform reaches a lower end-of-travel comprises a lower end-of-travel limit switch.

15. The combination ambulance and ambulance shock-absorbing platform for stretcher of claim 14 wherein said valve is an electrically-actuated valve, and further comprising a power supply connected to said valve and said prime mover through a position selection switch.

16. The combination ambulance and ambulance shock-absorbing platform for stretcher of claim 15 wherein said position selection switch is connected to said prime mover through said upper end-of-travel limit switch, and said position selection switch is connected to said valve through said lower end-of-travel switch.

17. The ambulance shock-absorbing platform for stretcher of claim 2 wherein said gas actuator is manufactured of resilient material, whereby gas pumped into said gas actuator by said pump increases a height of said gas actuator.

18. The ambulance shock-absorbing platform for stretcher of claim 2 wherein said gas actuator is a bellows, whereby gas pumped into said gas actuator by said pump increases a height of said gas actuator.

19. The ambulance shock-absorbing platform for stretcher of claim 2 wherein said gas actuator is a piston in cylinder, whereby gas pumped into said gas actuator by said pump increases a height of said gas actuator.

20. The ambulance shock-absorbing platform for stretcher of claim 2 wherein said gas actuator is a diaphragm, hereby gas pumped into said gas actuator by said pump increases a height of said gas actuator.

21. The combination ambulance and ambulance shock-absorbing platform for stretcher of claim 11 further comprising an ambulance floor recess in said ambulance floor sized to admit said gas actuators, said gas actuators being disposed within said ambulance floor recess.
